(19) United States
(12) Patent Application Publication
(10) Pub. No.: US 2005/0181178 A1
(43) Pub. Date: Aug. 18, 2005

(54) Shock absorbing member for vehicle cabin

(75) Inventors: Masaru Murayama, Komaki-shi (JP); Rentaro Kato, Kasugai-shi (JP); Takashi Inoue, Yonezawa-shi (JP)

Correspondence Address: OLIFF & BERRIDGE, PLC, P.O. BOX 19928, ALEXANDRIA, VA, 22320, US

(73) Assignees: Takashi INOUE, Yonezawa-shi (JP); TOKAI RUBBER INDUSTRIES, LTD., Komaki-shi (JP)

(21) Appl. No.: 10/979,424

(22) Filed: Nov. 3, 2004

(30) Foreign Application Priority Data
Nov. 12, 2003 (JP) 2003-382969

(51) Int. Cl. B32B 3/28

(52) U.S. Cl. 428/167

(57) ABSTRACT

A shock absorbing member for vehicle cabin having a molded article of synthetic resin material having a plurality of tabular ribs extending in an impact load input direction, wherein the synthetic resin material has normal temperature elongation at break of 200% or more, yield stress of 20 MPa or more, flexural modulus of 1 GPa or more, −20° C. elongation at break of 150% or more, and Izod impact strength of 10 kJ/m² or more.

### INCORPORATED BY REFERENCE

The disclosure of Japanese Patent Application No. 2003-382969 filed on Nov. 12, 2003 including the specification, drawings and abstract is incorporated herein by reference in its entirety.

### BACKGROUND OF THE INVENTION

1. Field of the Invention

The present invention relates to a shock absorbing member for automotive vehicle cabins, adapted to be disposed between a cabin structural member, such as a pillar and a roof side rail, and an interior part such as a garnish strip covering the interior-facing side of the cabin structural member, in order to absorb external shocks.

2. Description of the Related Art

Passenger cars or other automotive vehicles typically includes for forming cabins thereof cabin structural members (body panels) such as a roof panel, various pillars including a front pillar, center pillar, and rear pillar that support the roof panel, roof side panels that connect the tops of the pillars, and the like. For purposes such as enhancing the aesthetics of the vehicle interior, the cabin structural members are covered on the interior-facing side by interior parts such as roof linings and pillar garnish strips fabricated of synthetic resins or other materials.

In recent years, demands for higher levels of passenger safety in the event of a collision have led to the requirement that interior parts, and in particular pillar garnish strips which have a high risk of colliding with a passenger's head, be endowed with higher shock energy absorbing functionality.

As measures for meeting this requirement, JP-B-3051060, JP-A-11-268666, JP-A-2000-170814, and JP-A-2001-63484, for example, disclose disposing synthetic resin shock absorbing structures between cabin structural members and interior parts, in order to enhance levels of shock energy absorption in the event of a collision. These shock absorbing structures typically consist of moldings formed to predetermined shape from elastomer (EPR)/PP/talc alloy resins or the like, having a shock absorbing structure such as thin tabular ribs projecting upright at the basal end, latticed ribs composed of tabular ribs intersecting in a lattice, or the like. That is, these shock absorbing structures employ a basic structure composed of a plurality of thin tabular ribs, and accordingly, when subjected to shock during a collision, undergo plastic deformation and thereby absorb the energy of the shock.

However, extensive researches conducted by the inventors on these conventional shock absorbing structures reveals that these structures become disable to exhibit a desired shock absorbing capability under specific environments, and expose a passenger to a great danger, as well. Namely, automotive vehicles may be used in cold environments, where temperatures go below freezing, e.g., a few or several tens of degrees below the freezing, depending upon driving areas or driving hours. With this regards, the present inventors revealed that the synthetic resin shock absorbing structures disclosed in the above mentioned patent publications can undergo change in tensile characteristics, shock resistance and the like when subjected to ambient temperature change. As the ambient temperature decreases, tensile characteristics and shock resistance of the synthetic resin shock absorbing structures tend to decline. Therefore, in colder climates where temperatures go below freezing, there may occur the problem of an interior part or shock absorbing structure splitting or rupturing instead of undergoing appreciable plastic deformation during passenger impact, whereby the conventional shock absorbing structures suffer from considerable deterioration in shock absorbing capability. Also, due to the basic structure of thin tabular ribs, the shock absorbing structures broken into pieces may create sharp corners, thereby increasing the likelihood of causing injury. Besides, in a vehicle equipped with curtain side airbags, colder climates may cause the problem of splitting or rupturing when the airbag deploys, whereby the energy of the shock is not adequately absorbed during passenger secondary impact.

### SUMMARY OF THE INVENTION

It is therefore one object of this invention to provide a shock absorbing member for vehicle cabins, having high shock absorbing capability even in cold environments.

In the light of aforementioned novel technical sight, further extensive studies was made on materials and structures of shock absorbing members for vehicle cabins, and found that a combination of a specific structure and a specific material will provide a shock absorbing member having a high shock absorbing capability even in cold environments, e.g. −40° C. Thus, the inventors completed the present invention. Namely, the inventors found that the above mentioned object can be attained according to the principle of the invention, which provides a shock absorbing member for vehicle cabin a molded article of synthetic resin material having a plurality of thin tabular ribs extending in an impact load input direction, wherein the synthetic resin material has normal temperature elongation at break of 200% or more, yield stress of 20 MPa or more, flexural modulus of 1 GPa or more, −20° C. elongation at break of 150% or more, and Izod impact strength of 10 kJ/m² or more.

Elongation at break and yield stress herein refer to elongation at break and yield stress as defined by Japanese Industrial Standard (hereinafter abbreviated to as “JIS”) K7162. Flexural modulus refers to flexural modulus as defined by JIS-K7171. Izod impact strength refers to Izod impact strength as defined by JIS-K7110.

The shock absorbing member of the invention is fabricated of synthetic resin material having −20° C. elongation at break of 150% or above, and Izod impact strength of 10 kJ/m² or above. Thus, in a cold environment, when the shock absorbing member undergoes plastic deformation due to an applied shock, it will not split or rupture while undergoing a high level of deformation strain, but will instead undergo a sufficiently high level of plastic deformation. By means of this the shock absorbing member is able to exhibit very high shock energy absorbing capability, and to absorb sufficiently high levels of shock. Accordingly, the shock absorbing member of the invention is endowed with high shock energy absorbing capability, even in cold environments.

As long as the shock absorbing member has the specific structure of the plurality of thin tabular ribs and is formed of a synthetic resin material having the specific physical properties as set forth in the principle of the invention mentioned above, the shock absorbing member will exhibit excellent and stable shock absorbing capability even in cold environments including −40° C. Further, the present shock absorbing member is free from a problem of splitting or rupturing of ribs, eliminating the likelihood of causing injury.

According to one preferred form of the invention, the synthetic resin material will have −40° C. elongation at break of 150% or more and Izod impact strength of 7 kJ/m² or more. In this case, the material will have high shock energy absorbing capability under even more severe cold weather conditions.

Since the shock absorbing member of the invention is a molded article obtained by a molding process of synthetic resin material, it can be formed to any desired shape. For instance, the molded article can be given a structure having a basal portion and tabular ribs projecting upright in the basal portion, or structure having latticed ribs composed of tabular ribs intersecting in a lattice, or the like. Methods similar to those used in the past may be employed as molding processes, for example, injection molding, extrusion molding, or the like.

Preferably, each rib has a wall thickness within a range of 0.5-3.0 mm, more preferably 0.8-2.0 mm for further enhanced shock absorbing capability of the shock absorbing member. While, a variety of synthetic resin materials may be used in the invention, provided that they have the physical properties as set forth in the present invention, a thermoplastic resin composition disclosed in JP-A-2003-231796 may be suitably employed in the present invention.

According to another preferred form of the invention, the thermoplastic resin composition disclosed in JP-A-2003-231796 is used as the synthetic resin material used in the shock absorbing member of the invention. The thermoplastic resin composition disclosed in JP-A-2003-231796 is obtained by preparing a mixture that includes: a total of 100 parts by weight of resin consisting of 50-90 wt % polyester-type resin and 50-10 wt % polycarbonate resin; 5-100 parts by weight of a block copolymer composed of blocks containing at least one vinyl aromatic compound polymer and blocks containing at least one conjugated diene compound; and 0.1-5 parts by weight of a multifunctional isocyanate compound, and then by subjecting the mixture to compounding with a shear kneading apparatus at room temperature or higher, but temperature below the melting point of the polyester-type resin. This thermoplastic resin recently developed by the inventors meets the physical properties as set forth in the present invention, whereby the shock absorbing member of structure having the plurality of thin tabular ribs exhibits excellent shock absorbing capability even in cold environments. More preferably, the polyester-type resin may be polyethylene terephthalate and/or polybutylene terephthalate.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is a perspective view showing a vehicle cabin shock absorbing member of construction according to a first embodiment of the invention, mounted on a pillar garnish;

FIG. 2 is an exploded perspective view of FIG. 1;

FIG. 3 is a perspective view showing a vehicle cabin shock absorbing member of construction according to a second embodiment of the invention;

FIG. 4 is a view suitable for explaining the configuration and dimensions of test pieces used in Test 3;

FIG. 5 is a view suitable for explaining a method of executing Test 3;

FIG. 6 is a graph demonstrating measurements of static compression test in Test 3, taken at 23° C. (normal temperature);

FIG. 7 is a graph demonstrating measurements of static compression test in Test 3, taken at −40° C.;

FIGS. 8A and 8B are photographic views showing a result of Test 3 in a test piece of Example of the invention;

FIGS. 9A and 9B are photographic views showing a result of Test 3 in a test piece of Comparative Example 1; and

FIGS. 10A and 20B are photographic views showing a result of Test 3 in a test piece of Comparative Example 2.

### DETAILED DESCRIPTION OF PREFERRED EMBODIMENTS

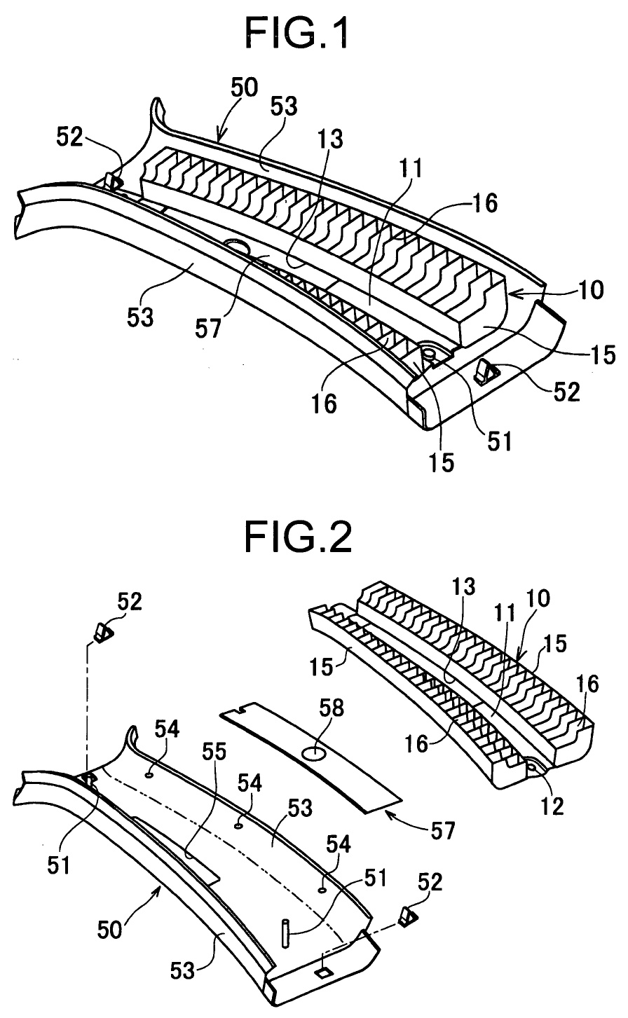

Referring first to FIG. 1, there is shown in perspective view a vehicle cabin shock absorbing member 10 of construction according to a first embodiment of the present invention. FIG. 2 shows an exploded perspective view of FIG. 1.

The shock absorbing member 10 of this embodiment is disposed between a center pillar (not shown) among the pillars that support the roof panel of a passenger car, and pillar garnish 50 which is an interior part for covering the interior-facing side of the center pillar. The shock absorbing member 10 consists of a resin molded article formed to a predetermined shape by injection molding using predetermined synthetic resin material (Mirai Kasei Co. Ltd., Product No. YV-20-2001). The synthetic resin material used here has normal temperature elongation at break of 200% or more, yield stress of 20 MPa or more, flexural modulus of 1 GPa or more, −20° C. elongation at break of 150% or more and Izod impact strength of 10 kJ/m² or more, and −40° C. elongation at break of 150% or more and Izod impact strength of 10 kJ/m² or more.

This shock absorbing member 10 has a basal portion 11 formed as an elongated tabular panel, and a pair of shock absorbing portions 15, 15 formed in box configuration extending from one lengthwise end to the other at both lateral sides of one face of the basal portion 11. This basal portion 11 has a pair of mounting holes 12 disposed at center portions of two lengthwise ends thereof for insertion of mounting bosses 51, 51 of a pillar garnish 50. Also provided in the generally center portion between the both lengthwise ends of the basal portion 11 is a generally rectangular opening 13 for passage of a seat belt anchor. A plurality of ribs 16 are disposed in parallel at predetermined intervals in the lengthwise direction of the basal portion 11, projecting upright from the basal portion 11. Preferably, each rib 16 has a wall thickness within a range of 0.5-3.0 mm, more preferably 0.8-2.0 mm.

This shock absorbing member 10 is mounted onto the pillar garnish 50 of polypropylene resin having an elongated shape of generally “C” shaped cross section. The mounting bosses 51, 51 for insertion into the mounting holes 12 of the shock absorbing member 10 are disposed at the both lengthwise ends of the pillar garnish 50 on the interior-facing side thereof. Spring clips 52, 52 for use when attaching the pillar garnish 50 to the center pillar are disposed outside the mounting bosses 51, 51 in the lengthwise direction. Side wall portions 53, 53 formed at both lateral sides of the pillar garnish 50, are individually provided with three projections 54 disposed on the inside faces at predetermined intervals in the lengthwise direction, for thereby fastening the shock absorbing member 10. In the generally lengthwise center portion of the pillar garnish 50, there is formed a rectangular opening 55 corresponding to opening 13 of shock absorbing member 10, and of generally the same size therewith.

Between the shock absorbing member 10 and the pillar garnish 50, a slide plate 57 of olefin elastomer with generally rectangular plate shape is disposed slidably in the lengthwise direction. In the approximately center portion of the slide plate 57, there is formed a round hole 58 for passage of a seatbelt anchor.

With the arrangement described above, the shock absorbing member 10 of the present embodiment is mounted on the pillar garnish 50, while being positioned between the center pillar and the pillar garnish 50, by attaching the pillar garnish 50 to the interior-facing side of the car center pillar by means of the spring clips 52, 52.

In the event that the head of passenger should impact the pillar garnish 50 due to an automobile collision, the shock absorbing member 10 undergoes plastic deformation through the action of plastic deformation of the pillar garnish 50, thereby absorbing the energy of impact. Since the shock absorbing member 10 is fabricated of synthetic resin material having −20° C. elongation at break of 150% or more and Izod impact strength of 10 kJ/m² or more, and −40° C. elongation at break of 150% or more and Izod impact strength of 10 kJ/m² or more, even in cold environments, the shock absorbing member 10 will not split or rupture while undergoing a high level of deformation strain, but will instead undergo a sufficiently high level of plastic deformation. Thus, the shock absorbing member 10 will be able to exhibit very high shock energy absorbing capability, and to absorb sufficiently high levels of shock.

As will be understood from the foregoing description, the shock absorbing member 10 of this embodiment is endowed with high shock energy absorbing capability, even in cold environments.

While the shock absorbing member 10 of the present embodiment is unified with the pillar garnish 50 by being mounted to the pillar garnish 50, the present invention is not particularly limited to this arrangement, but may otherwise be embodied with any possible arrangements. For instance, it is possible to use the shock absorbing member 10 independently.

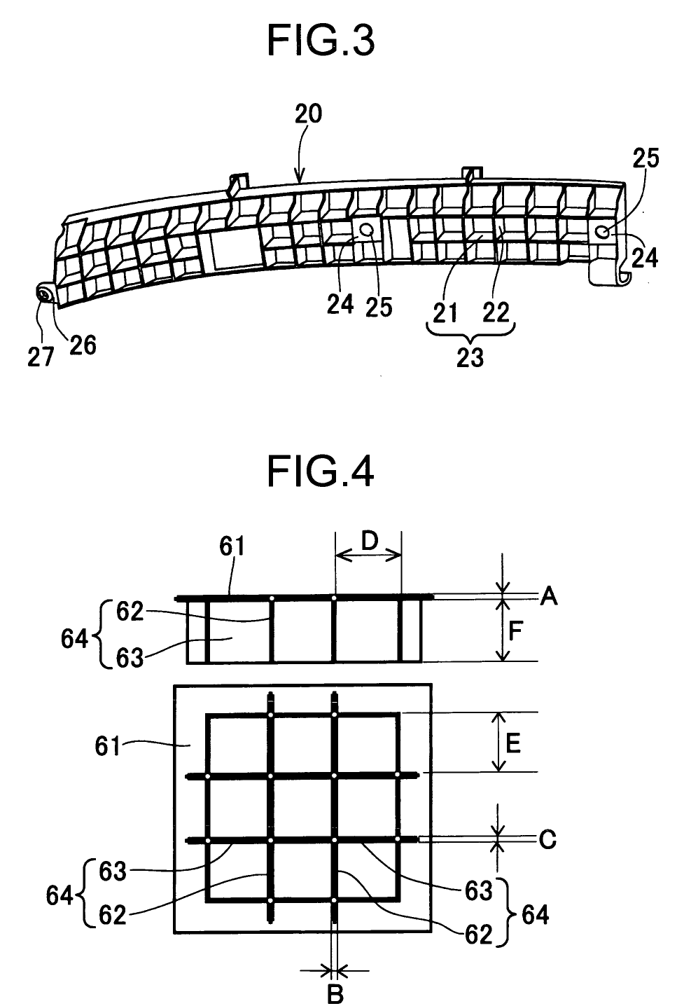

Referring next to FIG. 3, there is shown a vehicle cabin shock absorbing member 20 of construction according to a second embodiment of the invention, in a perspective view.

The shock absorbing member 20 of the present embodiment is disposed between a roof side rail (not shown) that connects the upper portions of the pillars that support the roof panel of a passenger car, and a roof lining (not shown) which is an interior part for covering the interior-facing side of the roof side rail and roof panel. The shock absorbing member 20 consists of a resin molded article formed to predetermined shape by injection molding using the same synthetic resin material as in the first embodiment, i.e., Mirai Kasei Co. Ltd., Product No. YV-20-2001. Accordingly, the synthetic resin material used here, like that of the first embodiment, has normal temperature elongation at break of 200% or more, yield stress of 20 MPa or more, flexural modulus of 1 GPa or more, −20° C. elongation at break of 150% or more and Izod impact strength of 10 kJ/m² or more, and −40° C. elongation at break of 150% or more and Izod impact strength of 10 kJ/m² or more.

This shock absorbing member 20 has lattice ribs 23 of considerable extension in the lateral direction, formed by the intersection at approximately right angles of tabular longitudinal ribs 21 extending in the longitudinal direction and tabular lateral ribs 22 extending in the lateral direction. The longitudinal ribs 21 and lateral ribs 22 are approximately 1.0 mm in wall-thickness. In spaces enclosed by the longitudinal ribs 21 and lateral ribs 22 at one lengthwise end of and at a generally central location in the shock absorbing member 20, bottom panels 24 are disposed so as to close off the bottom faces defining the spaces. These bottom planes 24 are provided with round mounting holes 25, 25 perforated through these bottom panels 24, 24. At the other lengthwise end of the shock absorbing member 20, there is disposed a projecting piece 26 that projects outwardly in the lengthwise direction, with a mounting hole 27 formed in this projecting piece 26.

The shock absorbing member 20 of this embodiment having the construction described above is installed between the roof side rail and the roof lining, with the member 20 being attached to the interior-facing side of the car roof side rail by means of mounting bolts (not shown) inserted through mounting holes 25, 25, 27.

The shock absorbing member 20 of this embodiment, like that of the first embodiment described earlier, is able to undergo a sufficiently high level of plastic deformation without splitting or rupturing while undergoing a high level of deformation strain. Accordingly, the shock absorbing member 20 will be able to exhibit very high shock energy absorbing capability, and to absorb sufficiently high levels of shock even in cold environments. Like in the first embodiment, the shock absorbing member 20 of this embodiment is endowed with high shock energy absorbing capability even in cold environments.

While the shock absorbing member 20 of this embodiment is disposed between the roof side rail and the rail lining, by means of suitable modification of its shape and size, it could also be installed between the roof panel and roof lining.

(Test 1)

A test was carried out for the purpose of ascertaining yield stress, elongation at break, and flexural modulus of synthetic resin materials used in the preceding embodiments. Elongation at break and yield stress were measured in accordance with the plastic tensile test method of JIS-K7162, by preparing 1A-type test pieces by means of injection molding, carrying out tests at tensile speed of 50 mm/min, at testing temperatures of 23° C. (normal temperature), 0° C., −20° C., and −40° C. Tests to ascertain flexural modulus were carried out according to the flexural test method of JIS-K7171, by preparing standard test pieces (10 mm width×4 mm thickness×80 mm length) by means of injection molding/machining processes, carrying out the tests with a distance of 64 mm between support points, testing speed of 2 mm/min, and testing temperature of 23° C. (normal temperature).

For Comparative Example 1, test pieces were prepared from a conventional synthetic resin material (CHISSO POLYPRO K7719 from Chisso Corp.), and for Comparative Example 2, test pieces were prepared from a conventional synthetic resin material (CHISSO POLYPRO K77194 from Chisso Corp.). These test pieces were tested in the same manner as the aforementioned Example of the invention. Results are presented in Table 1. In Table 1, the “*” symbol indicates that due to restrictions of the thermostatic chamber, elongation at break could only be measured up to 150%.

TABLE 1

| | | | Compar- | Compar- |
|---|---|---|---|---|
| | | | ative | ative |
| | | Example | Example 1 | Example 2 |
| 23° C. | Yield stress (MPa) | 30 | 23 | 22 |
| | Elongation at break (%) | 375 | 99 | 50 |
| | Flexural modulus (GPa) | 1.25 | 1.05 | 0.90 |
| 0° C. | Yield stress (MPa) | 40 | 29 | 32 |
| | Elongation at break (%) | >150 * | 85 | 30 |
| | Flexural modulus (GPa) | — | — | — |
| −20° C. | Yield stress (MPa) | 49 | 37 | 46 |
| | Elongation at break (%) | >150 * | 62 | 15 |
| | Flexural modulus (GPa) | — | — | — |
| −40° C. | Yield stress (MPa) | 59 | 52 | 58 |
| | Elongation at break (%) | >150 * | 11 | 8.0 |
| | Flexural modulus (GPa) | — | — | — |

As will be apparent from Table 1, at 23° C. (normal temperature), Comparative Example 1 showed higher values of yield stress, elongation at break and flexural modulus than did Comparative Example 2. However, while Comparative Example 1 and Comparative Example 2 both had yield stress of 20 MPa or more, and flexural modulus values around 1 GPa, elongation at break was less than 100%.

In the case of the Example, on the other hand, values of yield stress, elongation at break and flexural modulus were all even higher than those of Comparative Example 1, with yield stress of 20 MPa or more, elongation at break of 200% or more, and flexural modulus values of 1 GPa or more. In particular, the Example had a very high value of 375% for elongation at break, equivalent to approximately 3.8 times higher than that in Comparative Example 1 and approximately 7.5 times higher than that in Comparative Example 2. This reveals that the Example of the present invention is far superior to both Comparative Examples 1 and 2 in the measured physical properties.

In Comparative Examples 1 and 2, elongation at break declined gradually as the testing temperature dropped below 23° C. (normal temperature). At −20° C., in Comparative Example 1, it dropped by 62% to about 1/1.6 the value at 23° C. (normal temperature), and in Comparative Example 2, it dropped by 15% to about 1/3.3 the value at 23° C. (normal temperature). At −40° C., in Comparative Example 1, it dropped a further 11% to about 1/9 the value at 23° C. (normal temperature), and in Comparative Example 2, it dropped a further 8% to about ⅙ the value at 23° C. (normal temperature).

Regarding the Example of the invention, in contrast, although correct measurements could not be made at 0° C. −20° C., and −40° C. due to restrictions of the thermostatic chamber, while elongation at break was estimated to fall below 375% at 23° C. (normal temperature), it was 150% or above at 0° C., −20° C., and −40° C. That is, elongation at break characteristics of the synthetic resin material of the Example were clearly shown to be very good under cold temperature conditions of 0° C., −20° C., and −40° C.

(Test 2)

Test pieces were prepared from the synthetic resin materials used in the Example, Comparative Example 1 and Comparative Example 2. These test pieces were subjected to Izod impact strength testing in accordance with the test method of JIS-K7110. Tests were carried out with 1A-type test pieces produced by injection molding/machining processes, by means of edgewise impact at testing temperatures of 23° C. (normal temperature), 0° C., −20° C., and −40° C. Results are given in Table 2.

TABLE 2

| | Izod impact strength (kJ/m²) | | |
|---|---|---|---|
| Temperature | | Comparative | Comparative |
| condition | Example | Example 1 | Example 2 |
| 23° C. | N. B. | 16 | 27 |
| 0° C. | 12 | 11 | 12 |
| −20° C. | 11 | 8 | 8.0 |
| −40° C. | 7 | 6 | 6 |

As will be apparent from Table 2, at 23° C. (normal temperature), Comparative Example 1 was 16 kJ/m² and Comparative Example 2 was 27 kJ/m², giving generally satisfactory results. In the case of the Example, the test piece did not break (N. B) giving an amply satisfactory result.

Izod impact strength of the Example, Comparative Example 1 and Comparative Example 2 gradually declined as testing temperature dropped from 23° C. (normal temperature). Comparative Examples 1 and 2 had generally equal values at 0° C., −20° C., and −40° C. In the case of the Example, however, values were greater than those with Comparative Examples 1 and 2 at 0° C., −20° C., and −40° C.

From the above, it was clear that the Example exhibits higher Izod impact strength than did Comparative Examples 1 and 2, not only at 23° C. (normal temperature), but also in cold environments of −20° C., and −40° C.

(Test 3)

Test pieces like that depicted in FIG. 4 were prepared from the synthetic resin materials of the Example and Comparative Example 1 and 2, and subjected to static compression tests. As shown in FIG. 4, each test piece comprises a basal portion 61 of square-panel shape, and lattice ribs 64 formed by intersection of four tabular longitudinal ribs 62 projecting upright from the basal portion 61 and extending in the longitudinal direction, and four tabular lateral ribs 63 extending in the lateral direction. Thickness: A of the basal portion is 2.5 mm. Thickness: B of longitudinal ribs 62 is 1.2-1.7 mm. Thickness: C of lateral ribs 62 is 1.2-1.7 mm. Center-to-center distance: D between adjacent longitudinal ribs 62 is 30 mm. Center-to-center distance: E between adjacent lateral ribs 63 is 30 mm. Height F of both longitudinal ribs 62 and lateral ribs 63 is 30 mm.

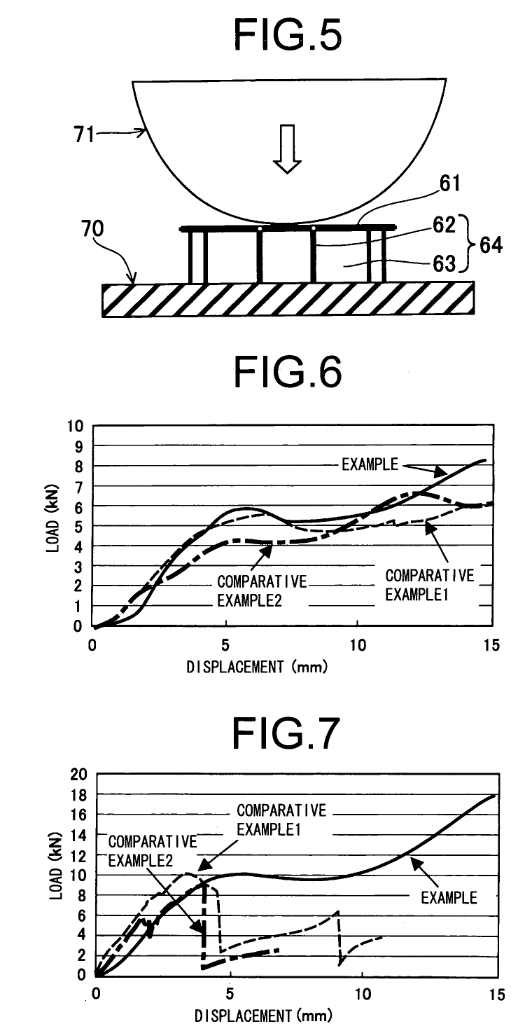

The test is carried out by placing the test piece on a stage 70 with the lattice rib 64 side facing down, as shown in FIG. 5, and pressing down on the upper face of the basal portion 61 of the test piece at a speed of 20 mm/min with the spherical face of a pressing portion 71 of semi-spherical shape fabricated of aluminum. The relationship between the load (kN) applied by this pressing and the extent of displacement (mm) of the test piece during pressing was tracked under environmental temperatures of 23° C. (normal temperature) and −40° C. Measurements taken at 23° C. (normal temperature) are given in FIG. 6, and measurements taken at −40° C. are given in FIG. 7.

In FIGS. 6 and 7, the amount of energy absorbed by each test piece is equivalent to an area bounded by the characteristic curve thereof, and the horizontal axis indicating the extent of displacement. A larger area will be evaluated as having greater energy absorption.

As will be apparent from FIG. 6, at 23° C. (normal temperature), characteristic curves for the Example, Comparative Example 1, and Comparative Example 2 are generally of the same shape. However, in the case of the Example, maximum load slightly exceeds 8 kN, which is higher than the maximum load for Comparative Example 1 (about 6.5 kN) and the maximum load for Comparative Example 2 (about 6 kN). When energy absorption by test pieces is compared in terms of area bounded by the characteristic curve and the horizontal axis indicating the extent of displacement, it will be seen that while Comparative Example 1 and Comparative Example 2 are generally similar, energy absorption of the Example is greater than those of Comparative Examples 1 and 2.

Additionally, as will be apparent from FIG. 7, at −40° C., in the case of Comparative Example 2, appreciable splitting (breakage) occurred when displacement reached about 4 mm (load: approximately 9 kN) from the initial rise. Thus, at displacement of about 4 mm, the characteristic curve for Comparative Example 2 falls precipitously from a load of 9 kN to around 0.5 kN, with a subsequent gentle rise to an end point where displacement is approximately 7 mm. Accordingly, it will be appreciated that energy absorption by Comparative Example 2 having this characteristic curve is very small.

In the case of Comparative Example 1, appreciable splitting (breakage) occurred when displacement reached about 4.5 mm (load: approximately 8 kN) from the initial rise, and again when displacement reached about 9 mm (load: approximately 8 kN). Thus, the characteristic curve of Comparative Example 1, after reaching a load value peak (approximately 10 kN) when displacement reaches about 3.5 mm from the initial rise, subsequently falls precipitously from a load of 8 kN to around 2 kN at displacement of approximately 4.5 mm, with a subsequent gentle rise until displacement is approximately 9 mm. When displacement reaches approximately 9 mm, there is another precipitous fall in load value from approximately 6 kN to around 1 kN, with a subsequent moderately sharp rise until displacement is approximately 11 mm. Accordingly, energy absorption by Comparative Example 1 having this characteristic curve is small. However, when energy absorption by Comparative Example 1 and Comparative Example 2 is compared, since the characteristic curve of Comparative Example 1 is always situated above (i.e. higher load value end) the characteristic curve of Comparison 2, energy absorption amount of Comparative Example 1 will be understood to be some 2 to 3 times greater.

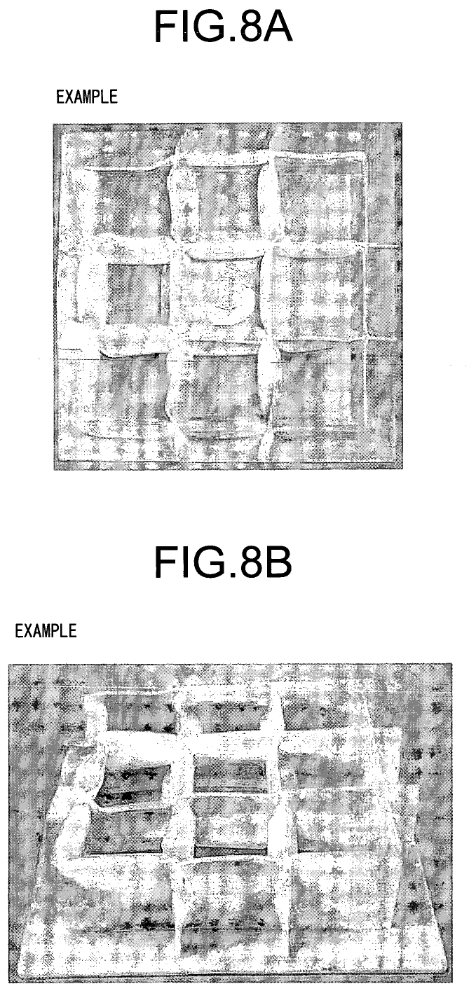

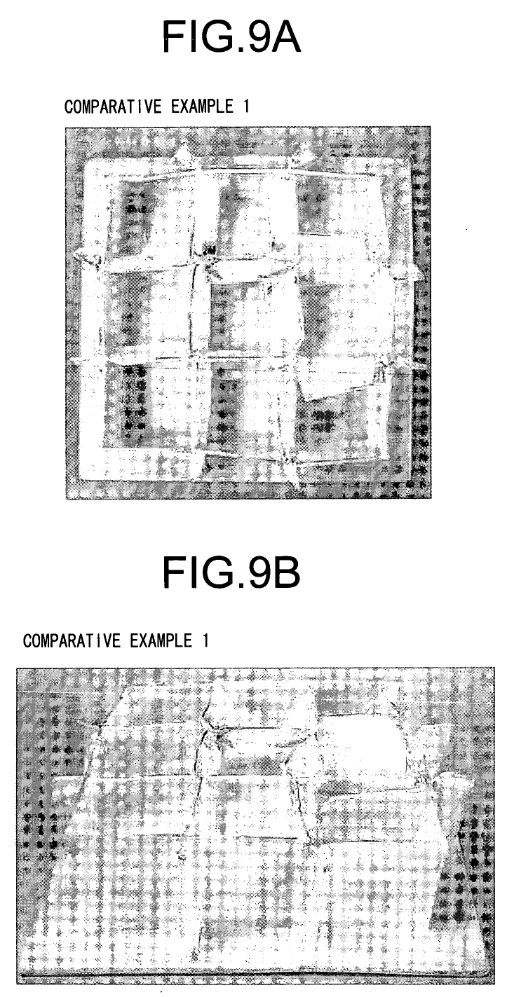

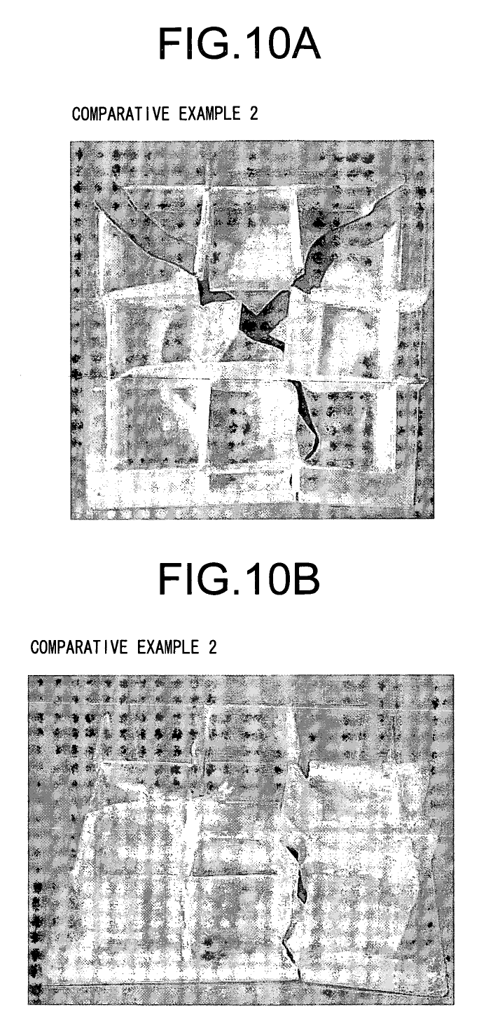

In contrast, the characteristic curve of the Example in the initial stage rises sharply until load reaches 10 kN and displacement reaches approximately 5 mm, and subsequently maintains substantially constant load unit displacement reaches 10 mm, and then rises moderately sharply to an end point where displacement reaches 15 mm. That is, the characteristic curve of the Example has an ever-increasing rise apart from the range of substantially constant load of about 10 kN (displacement range of about 5-10 mm). It should be appreciated that in the case of the Example, no splitting or breakage occurs until displacement reaches its maximum of 15 mm, as shown in FIGS. 8A and 8B, although Comparative Examples 1 and 2 result in occurrence of splitting or breakage as shown in FIGS. 9A, 9B, 10A, and 10B, respectively. It will accordingly be apparent that energy absorption of the Example having such a characteristic curve is on the order of four times that of Comparative Example 1.

It will be understood from the preceding that under a −40° C. cold environment, the Example affords markedly greater energy absorption than do Comparative Example. 1 and Comparative Example 2. From these results it may be postulated that high energy absorption would be achieved over an even large range of testing speeds, i.e. impact compression tests as well, making the material very suitable as a synthetic resin material for use in a shock absorbing member.

It is to be understood that the present invention may be embodied with various other changes, modifications and improvements, which may occur to those skilled in the art, without departing from the spirit and scope of the invention defined in the following claims.

1. A shock absorbing member for vehicle cabin, comprising:
a molded article of synthetic resin material having a plurality of tabular ribs extending in an impact load input direction,
wherein the synthetic resin material has normal temperature elongation at break of 200% or more, yield stress of 20 MPa or more, flexural modulus of 1 GPa or more, −20° C. elongation at break of 150% or more, and Izod impact strength of 10 kJ/m² or more.

2. A shock absorbing member according to claim 1, wherein the synthetic resin material has −40° C. elongation at break of 150% or more and Izod impact strength of 7 kJ/m² or more.

3. A shock absorbing member according to claim 1, wherein the molded article has a structure including a basal portion on which the plurality of thin tabular ribs project upright.

4. A shock absorbing member according to claim 1, wherein the plurality of thin tabular ribs include longitudinal ribs and lateral ribs intersecting in a lattice.

5. A shock absorbing member according to claim 1, wherein the synthetic resin material comprises a thermoplastic resin composition obtained by preparing a mixture that includes: a total of 100 parts by weight of resin consisting of 50-90 wt % polyester-type resin and 50-10 wt % polycarbonate resin; 5-100 parts by weight of a block copolymer composed of blocks containing at least one vinyl aromatic compound polymer and blocks containing at least one conjugated diene compound; and 0.1-5 parts by weight of a multifunctional isocyanate compound, and then by subjecting the mixture to compounding with a shear kneading apparatus at room temperature or higher, but temperature below the melting point of the polyester-type resin.

6. A shock absorbing member according to claim 5, wherein the polyester-type resin is at least one of polyethylene terephthalate and polybutylene terephthalate.

7. A shock absorbing member according to claim 1, wherein each of the plurality of tabular ribs has a wall thickness within a range of 0.5-3.0 mm.
